(19) United States
(12) Patent Application Publication
(10) Pub. No.: US 2008/0012605 A1
(43) Pub. Date: Jan. 17, 2008

(54) Glitch-free clock switcher

(75) Inventor: Hung K. Cheung, Fremont, CA (US)

Correspondence Address: Pamela R. Crocker;Patent Legal Staff, Eastman Kodak Company, 343 State Street, Rochester, NY, 14650-2201, US

(73) Assignee: Eastman Kodak Company

(21) Appl. No.: 11/485,225

(22) Filed: Jul. 12, 2006

(51) Int. Cl. G06F 1/08

(52) U.S. Cl. 327/99

(57) ABSTRACT

A glitch-free, clock switching circuit in which an asynchronous, sequential logic circuit has as inputs a clock select signal and a pair of clock signals. A plurality of operating state variable signals are generated in the sequential logic circuit in response to transitions in the input signal. A combinational logic clock output circuit is responsive to the input clock signals and predetermined ones of the operating state variable signals for outputting a newly selected clock signal only when said predetermined operating state variable signals indicate the sensing of a falling edge of the currently outputted clock signal followed by a falling edge of the newly selected clock signal.

### FIELD OF THE INVENTION

The invention relates generally to the field of digital clock switching circuits and, in particular, to a glitch-free clock switcher circuit that enables selection of an output clock signal from a plurality input clock signals of different frequencies without resulting in the output of arbitrarily short clock pulses.

### BACKGROUND OF THE INVENTION

In digital circuits, clock sources provide pulsed timing signals which allow for appropriate timing and ordering events occurring within the circuits. It is desirable in many of those circuits to allow the clock source for the circuit to be switched from time to time between any of a plurality of clock sources. It is important when switching clock signals to avoid outputting arbitrarily short pulses that are shorter than any of the clock source signals, referred to commonly as “glitches” in order to maintain proper operation of the digital circuits.

Numerous attempts have been made to provide clock switcher circuits that avoid glitches in the output clock signals. Examples such attempts are found in U.S. Pat. Nos. 6,774,681 B2; 6,784,699 B2; and 6,275,546 B1 which typically require excessive amount of control signals to function and/or have very high gate counts, e.g. 41 or higher, which adds to the cost and complexity of the circuits.

A clock switcher circuit described in IBM Technical Disclosure Bulletin, Vol. 32, No. 9B, February 1990 entitled “Method to Select One of Two Clocks While Avoiding Narrow Pulses” which utilizes a state machine comprising a pair of clock-controlled D flip flops to control operating states of the circuit in an effort to ensure that short cycle pulses are not generated in the switching operation. While effective to some extent, the circuit is not truly glitch free with an asynchronous clock select signal. This is because occurrence of the falling or rising edge of the select signal at certain times between positive edge of the clock 2 and clock 1 signals or between the rising edges of the clock 1 and clock 2 will cause the premature interruption of the output clock pulses since at these times the outputs of the D flip flops state machine are both active low. The problem is inherent with the use of D flip flops in the circuit which are constrained to change state only on the input clock edge.

There is a need therefore for a simple, low cost, glitch-free, clock switcher circuit that operates effectively and reliably with totally asynchronous clock and clock select input signals without the need for a multiplicity of control signals or excessive gate counts in the circuit structure.

### SUMMARY OF THE INVENTION

The present invention is directed to overcoming one or more of the problems set forth above. Briefly summarized, according to an aspect of the present invention, there is provided a glitch-free, clock switching circuit that comprises an asynchronous, sequential logic circuit having as inputs a clock select signal and a pair of clock signals and responsive thereto for generating a plurality of operating state variable signals. The switching circuit also includes a combinational logic clock output circuit responsive to the input clock signals and predetermined ones of the operating state variable signals for outputting a newly selected clock signal only when the predetermined operating state variable signals indicate the sensing of a falling edge of the currently outputted clock signal followed by a falling edge of the newly selected clock signal.

The above and other objects of the present invention will become more apparent when taken in conjunction with the following description and drawings wherein identical reference numerals have been used, where possible, to designate identical elements that are common to the figures.

These and other aspects, objects, features and advantages of the present invention will be more clearly understood and appreciated from a review of the following detailed description of the preferred embodiments and appended claims, and by reference to the accompanying drawings.

### ADVANTAGEOUS EFFECT OF THE INVENTION

The present invention has the following advantages:

The switching circuit is glitch free and has no short cycling output. No restrictions on the input clock sources and there is no need to know which one has the highest frequency. The circuit introduces only two gate delays from input to output. No flip flops are employed in the circuit, the flip flop functions are being merged into common logic for speed. The circuit has a low gate count (23 gates for a 2-1 clock switcher) and is cascadable to handle switching of more than two clock sources. The circuit has low power consumption since it employs asynchronous circuit implementation. Finally, there is no need to employ initialization since the circuit inherently initializes itself after power up.

### BRIEF DESCRIPTION OF THE DRAWINGS

FIG. 1 is a simplified block diagram of the switcher circuit;

FIG. 2 is a logic circuit implementation of the switching circuit of the invention;

FIG. 3 is an operating state diagram for the circuit of FIG. 2;

FIGS. 4A and 4B are timing diagrams useful in illustrating operation of the circuit for an arbitrarily selected sequence of asynchronous input signals;

FIG. 5 is an example of a cascaded system of switching circuit for selecting from among more than two input clock signals; and

FIG. 6 is a more generalized illustration of the cascading of switching circuits for any number of clock signals.

### DETAILED DESCRIPTION OF THE INVENTION

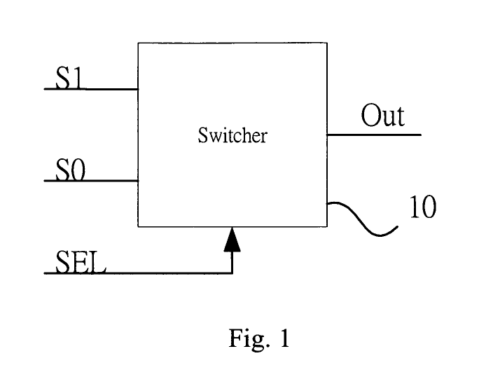

Referring to FIG. 1, the basic 2-1 clock switching circuit 10 is shown having a clock select input signal SEL and a pair of clock input signals S1 and S0. The clock signals are of different frequencies and are asynchronous to each other. For operation of the circuit, it is not necessary to designate which of the clock signals is the higher frequency signal. Clock select signal SEL is a simple bi-state selection and the clock selection transition may be asynchronous with the two clock signals.

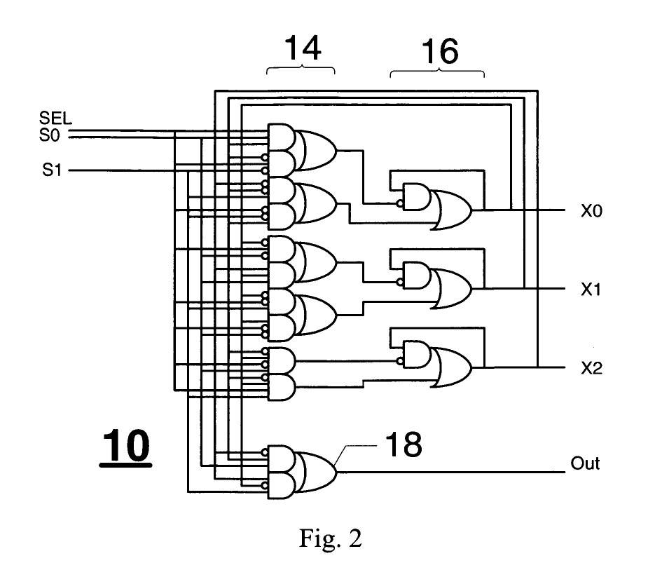

FIG. 2 illustrates a presently preferred embodiment of the invention configured in accordance with the design process described later. In this embodiment, switching circuit 10 comprises an asynchronous, sequential logic circuit having, as inputs, clock select signal SEL, and clock signals S0 and S1. Consistent with sequential logic circuit design, circuit 10 includes an input logic stage 14 and an operating state machine 16. In addition to the clock select and clock signals, the input logic stage also has, as inputs, operating state variable signals X2, X1 and X0 fed back from the operating state machine 16. The input logic stage 14 is responsive to the input signals to generate a set of reset and set inputs R and S to respective ones of the RS latches in the state machine 16. The state signals are event driven, meaning that changes in the state signals are driven by transitions in the input signals (events) which are conveyed to the latches via the transitions in the reset and set signals R and S.

In addition to the sequential logic circuit, the switching circuit 10 includes a combinational logic clock output circuit 18 which is responsive to the input signals SEL, S0, S1 and the state signals from state machine 16 to output a newly selected clock signal only when the state signals indicate the sequential sensing of a falling edge of the currently outputted clock signal followed by a falling edge of the newly selected clock signal.

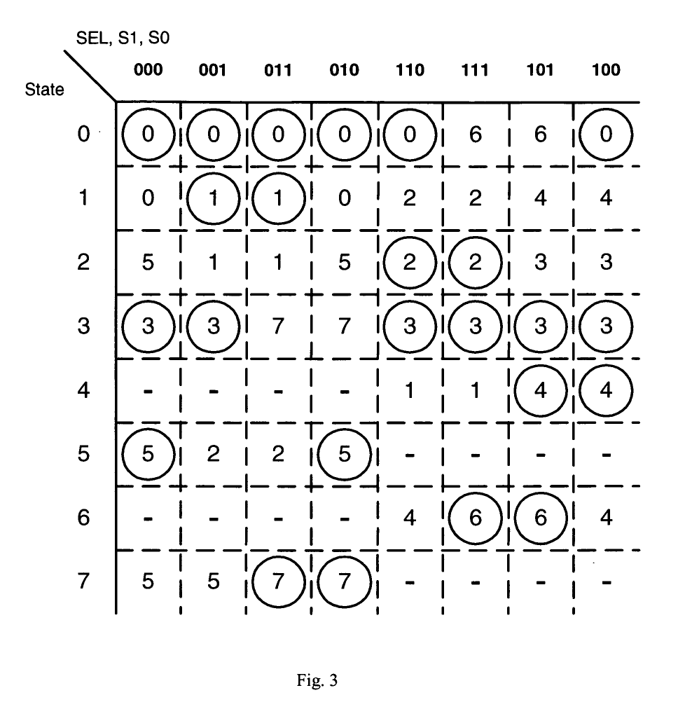

In accordance with the teachings of the invention, the procedure for establishing the configuration of a clock switching circuit, such as circuit 10, begins with creating a state diagram such as shown in FIG. 3 in which the columns represent the eight possible input signal transitions that can occur and the rows represent the operating states 0-7 that correspond to the eight possible combinations of the binary operating states X2, X1, and X0 resulting from the input signal transitions. Certain basic premises are established for populating the boxes in the diagram. A first premise is that the switching circuit will have two usual operating states, arbitrarily designated as states 0 and 3 in the illustrated diagram, in which the output of the circuit will follow either input signal S0 (state 0) or S1 (state 3). A second premise is that each state transition (from one state to another state) change only one state variable X2, X1, or X0. A third premise is that, following a transition of input signal SEL, a predetermined sequence of transitions of input signals S0 and S1 will result in changing between states 0 and 3. In the illustrated diagram, this last premise is that, after a transition of the SEL signal, a falling edge of the currently outputted clock signal followed by the falling edge of the newly selected edge of the newly selected clock signal will result in the desired changeover from the old to the new clock signal being outputted from the switching circuit.

In the diagram, the circles indicate stable states awaiting an ensuing input signal transition. The uncircled numbers indicate transitional states leading to the state rows indicated by the numbers. Starting with the upper left corner, the number 0 is inserted in the first four boxes of the state row 0 indicating the circuit is outputting S0 and SEL is unchanged at 0. State number 0 is also inserted in the fourth and eighth boxes in row 0 indicating SEL=1, S0=0 and is waiting for S0 to go high. In a similar vane, state number 3 is inserted in the last four boxes of state row 3 indicating the circuit is outputting S1 and SEL is unchanged at 1, while boxes 1 and 4 are filled in with state number 3 to indicate SEL=0 and the circuit is waiting for S1 to go high.

The intermediated transitional state numbers are then inserted in an orderly sequence that leads to compliance with the premise on which changeover occurs between states 0 and 3. Assuming the input conditions of SEL=1, S0=0 and S1 goes high, the sixth and seventh boxes in state row 0 are filled in with state number 6 to indicated a change to state 6 in state row 6. The meaning of this stable state is that the circuit is now waiting for S0 to transition low (S0=0). When this occurs, the state number 4 in the fifth and eighth boxes of state row 6 indicate a state change to state row 4. If the input transitioned from 111 to 110, the state moves in column 6 to through state rows 4, 1 to stable state 2 in state row 2. At this point, the falling edge of S0 has been detected and the circuit is now awaiting an ensuing falling edge of S1 which is the meaning of state 2. When this occurs (in either column 7 or 8) the circuit moves to the usual stable state 3 in state row 3 which means that the circuit output is now following S1 thereby completing the switch from clock S0 to S1. If, while in state 6, the input had transitioned from 101 to 100, the state then moves directly to stable state 4 in state row 4, column 8. At this point, the circuit has detected the falling edge of S0 and is now waiting for the ensuing falling edge of S1. However, since S1 in column 8 is low (S1=0), the circuit must first detect the transition of S1 to a 1 (in either of columns 5 or 6 of state row 4). When this occurs, the circuit moves to state 2 via state row 1 to await the occurrence of the falling edge of S1 and change to state 2 with the consequent changeover of the output from S0 to S1, as described above.

Population of the remainder of the diagram is completed by following the above description. In the diagram, the boxes without numbers represent “don't care” states meaning that it is not possible to arrive at these particular states given the input signal combinations in the respective columns.

Once the state diagram is created, state assignments can then be established to conform with the diagram. The general procedure for assigning state variables is described by James H. Tracey in an article entitled “Internal State Assignments for Asynchronous Sequential Machines” found in the August 1966 edition of IEEE Transactions on Electronic Computers. As applied herein, it is important to note, as stated above, that each state transition (from one state to another state) change only one state variable. Thus, for the circuit 10, the state assignments used are as shown in Table I.

TABLE I

| State | X2 | X1 | X0 |
|---|---|---|---|
| 0 | 0 | 1 | 1 |
| 1 | 0 | 0 | 1 |
| 2 | 1 | 0 | 1 |
| 3 | 1 | 0 | 0 |
| 4 | 0 | 0 | 0 |
| 5 | 1 | 1 | 1 |
| 6 | 0 | 1 | 0 |
| 7 | 1 | 1 | 0 |

Once the state assignments have been established, the state diagram is then converted to a Karnaugh map (“K-map”), a process known in the art from which an optimized set of equations for the state machine and output can be derived. For the state diagram of FIG. 3, the following set of optimized equations are derived:

R(X2)=˜X1 & X0 & ˜SEL & S0

S(X2)=˜X1 & X0 & SEL & S1

R(X1)=(˜X0 & SEL & ˜S0)|(X2 & X0 & S0)

S(X1)=(X0 & ˜SEL & ˜S0)|(˜X0 & ˜SEL & S1)

R(X0)=(˜X1 & SEL & ˜S1)|(X1 & SEL & S0)

S(X0)=19 X2 & ˜X1 & S1)|(X1 & ˜SEL & ˜S1);

SOUT=(˜X2 & X1 & S0)|(X2 & ˜X0 & S1)

where R and S are the Reset and Set outputs of the input logic stage 14 applied to the inputs of the ensuing state machine 16, and SOUT is the output signal from the logic output circuit 18. The logic circuit of FIG. 2 is then constructed in accordance with these equations.

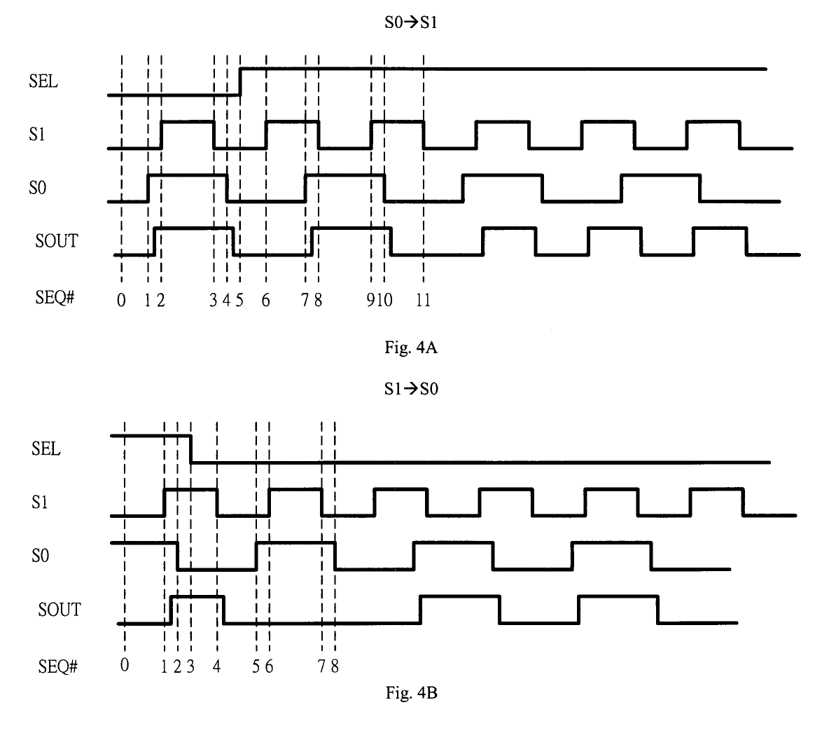

To aid in describing the operation of the FIG. 2 circuit, timing diagrams are shown in FIGS. 4A and 4B for two arbitrary patterns of input signals SEL, S1, S0. The pattern for the output signal SOUT is slightly delayed relative to its corresponding input signal S1 or S0 to reflect the two gate delay in the logic circuit 18. Based on the state diagram of FIG. 3 and the timing diagrams of FIGS. 4A and 4B, Tables II and III, below, illustrate the sequence of states that occur at each successive transition of the input signals. The input signal transitions are numbered in sequence.

TABLE II
Switch S0 → S1

| | Inputs | | | | |
|---|---|---|---|---|---|
| Seq. # | SEL | S1 | S0 | State | Comment |
| 0 | 0 | 0 | 0 | 0 | SOUT = S0 |
| 1 | 0 | 0 | 1 | 0 | |
| 2 | 0 | 1 | 1 | 0 | |
| 3 | 0 | 0 | 1 | 0 | |
| 4 | 0 | 0 | 0 | 0 | |
| 5 | 1 | 0 | 0 | 0 | SEL = S1 |
| 6 | 1 | 1 | 0 | 0 | |
| 7 | 1 | 1 | 1 | 6 | |
| 8 | 1 | 0 | 1 | 6 | |
| 9 | 1 | 1 | 1 | 6 | |
| 10 | 1 | 1 | 0 | 2 | FE S0 |
| 11 | 1 | 0 | 0 | 3 | FE S1, SOUT = S1 |

Thus, for the timing diagram of FIG. 4A, all inputs initially are low (seq. #0 in Table II) and the circuit resides in state 0 (first row, first column) in the state diagram, consistent with the current output of clock S0. For input transition seq. # 1-seq. #4, SEL remains low and the circuit remains in state 0 (first row) with SOUT following clock S0. When SEL goes high (seq. #5) to initiate a switch of SOUT to clock 0, no state change occurs until seq. #7 (sixth col.) which forces a change to state 6 (row 6). The logic circuit is now looking for a falling edge of S0 (the current clock) which occurs at seq. #10 and which forces a change to state 2 (row 2, sixth col.). The logic circuit is now looking for a falling edge of the newly selected clock S1 which occurs at the next seq. #11 which forces a change to state 3 (row 3, eighth col.). As noted above, once the circuit changes to state 3, SOUT follows input clock S1 and the switching is now complete.

TABLE III
Switch S1 → S0

| | Inputs | | | | |
|---|---|---|---|---|---|
| Seq. # | SEL | S1 | S0 | State | Comment |
| 0 | 1 | 0 | 1 | 3 | SOUT = S1 |
| 1 | 1 | 1 | 1 | 3 | |
| 2 | 1 | 1 | 0 | 3 | |
| 3 | 0 | 1 | 0 | 7 | SEL = S0 |
| 4 | 0 | 0 | 0 | 5 | FE S1 |
| 5 | 0 | 0 | 1 | 2 | Unstable state 2 |
| | 0 | 0 | 1 | 1 | Stable state 1 |
| 6 | 0 | 1 | 1 | 1 | |
| 7 | 0 | 0 | 1 | 1 | |
| 8 | 0 | 0 | 0 | 0 | FE S0, SOUT = S0 |

A similar analysis of the timing diagram in FIG. 4B produces the input transition sequence of Table III for switching from S1 to S0. This table shows that, initially, the circuit 10 is in state 3 (row 3) with SOUT=S1. The transition to SEL S0 at seq. #3 forces a state change to state 5 after which the falling edge of the current clock S1 is detected at seq. #4. After changing to state 1 at seq. #5, the logic circuit looks for the falling edge of the newly selected clock pulse S0 which occurs at seq. #8 and, thereafter, SOUT follows S0.

It should be noted that the sequential change of states of the logic circuit configured in accordance with the state diagram of FIG. 3 assures that the circuit 10 avoids truncation of any output clock pulse regardless of the asynchronous timing of the transition of the SEL signal, thereby assuring a glitch-free, clock switching operation. It will be appreciated that, in accordance with the teachings of the invention herein, other state diagrams and corresponding logic circuits can be constructed which will similarly assure glitch-free switching between input clock pulse signals.

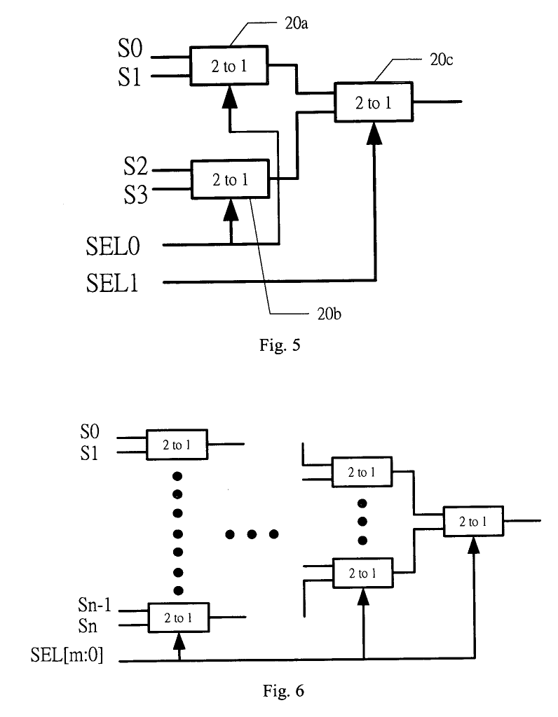

By cascading the clock switching circuits as shown in FIG. 5, glitch-free switching among three or more input clock signals may be accomplished. In FIG. 5, three switching circuits 20a, 20b, 20c, each configured as described above, are used to switch among four input clocks S0-S3 with two clock select signals SEL0, SEL1. The corresponding conditional selection logic applies:

If {SEL1, SEL0}=00, SOUT=S0

If {SEL1, SEL0}=01, SOUT=S1

If {SEL1, SEL0}=10, SOUT=S2

If {SEL1, SEL0}=11, SOUT=S3

In FIG. 6, a more generalized configuration of the cascading of the switching circuits of the invention for any number “n” of input clock signals in which the number of clock select inputs “m” is the number of columns of cascaded circuits needed to arrive at a singular output clock signal.

The invention has been described with reference to a preferred embodiment. However, it will be appreciated that variations and modifications can be effected by a person of ordinary skill in the art without departing from the scope of the invention.

### Parts List

10 2-1 clock switching circuit
14 input logic stage
16 operating state machine
18 combinational logic clock output circuit
20a cascaded switching circuit
20b cascaded switching circuit
20c cascaded switching circuit

1. A glitch-free, clock switching circuit comprising:
an asynchronous, sequential logic circuit having as inputs a clock select signal and a pair of clock signals and responsive thereto for generating a plurality of operating state variable signals; and
a combinational logic clock output circuit responsive to the input clock signals and said operating state variable signals for outputting a newly selected clock signal only when the operating state variable signals indicate the sequential sensing of a falling edge of the currently outputted clock signal followed by a falling edge of the newly selected clock signal.

2. The switching circuit of claim 1 wherein:
the asynchronous, sequential logic circuit comprises an input logic stage and operating state machine;
the input logic stage having, as inputs, said clock select signal, and said pair of clock signals and said operating state variable signals fed back from the operating state machine, the input stage producing predetermined combinations of set and reset signals as inputs to the operating state machine; and
the operating state machine having latches directly responsive to said set and reset signals independently of said clock signals to generate said plurality of operating state variable signals respectively indicating event driven variable operating states of the switching circuit during the course of changing from one clock signal to another.

3. The switching circuit of claim 2 wherein the operating state machine comprises a plurality of RS flip flop latches which generate state output variables, X2, X1, X0 in accordance with the following state assignment table:

| State | X2 | X1 | X0 |
|---|---|---|---|
| 0 | 0 | 1 | 1 |
| 1 | 0 | 0 | 1 |
| 2 | 1 | 0 | 1 |
| 3 | 1 | 0 | 0 |
| 4 | 0 | 0 | 0 |
| 5 | 1 | 1 | 1 |
| 6 | 0 | 1 | 0 |
| 7 | 1 | 1 | 0 |

as determined by reset R and set S signals inputted thereto;
the input logic stage comprises a logic circuit configuration that generates said R and S signals in accordance with the equations:
R(X2)=˜X1 & X0 & ˜SEL & S0
S(X2)=˜X1 & X0 & SEL & S1
R(X1)=(˜X0 & SEL & ˜S0)|(X2 & X0 & S0)
S(X1)=(X0 & ˜SEL & ˜S0)|(X0 & SEL & S1)
R(X0)=(˜X1 & SEL & ˜S1)|(X1 & SEL & S0)
S(X0)=(˜X2 & ˜X1 & S1)|(X1 & SEL & S1); and
the output logic circuit is structured in conformance to the output equation:
OUT=(˜X2 & X1 & S0)|(X2 & ˜X0 & S1).

4. A clock switching circuit comprising:
an input receiving asynchronous input signals having a pair of clock signals of different frequencies and a clock select signal;
an output conveying as an output signal one of the pair of input signals;
a set of logic gates receiving the input signals and generating state signals enabling output of a selected one of the input clock signals, the logic gates configured to change a state of the clock switching circuit with each transition of the input signals to enable the switchover from a current output clock signal to a newly selected clock signal only upon occurrence after selection of a new clock signal of a falling edge of the current output clock signal followed by a falling edge of the newly selected clock signal.
